(19) United States
(12) Patent Application Publication
(10) Pub. No.: US 2026/0352256 A1
(43) Pub. Date: Nov. 5, 2026

(54) CAPABILITY REPORTING FOR SUCCESSIVE INTERFERENCE CANCELLATION

(71) Applicant: QUALCOMM Incorporated, San Diego, CA (US)

(72) Inventors: Ahmed Attia ABOTABL, San Diego, CA (US); Carles DIAZ VILOR, San Diego, CA (US)

(21) Appl. No.: 19/199,198

(22) Filed: May 5, 2025

(51) Int. Cl. H04B 1/7107; H04L 1/00; H04W 72/21; H04W 72/51

(52) U.S. Cl. CPC H04B 1/71072; H04L 1/0003; H04W 72/21; H04W 72/51

(57) ABSTRACT

Systems and techniques are provided for wireless communications. For example, an apparatus can transmit, to a network entity, information indicative of one or more parameters corresponding to a successive interference cancellation (SIC) capability of the apparatus. The SIC capability can correspond to support by the apparatus for SIC-based decoding. The apparatus can receive, from the network entity, a downlink transmission configured based on the SIC capability of the apparatus.

### INTRODUCTION

Aspects of the present disclosure generally relate to wireless communication. In some implementations, examples are described for reporting capability information associated with successive interference cancellation (SIC) for spatially coupled multiple input-multiple output (SC-MIMO) communications.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, an apparatus of a user equipment (UE) for wireless communication is provided. The apparatus includes a processing system, where the processing system is configured to: transmit, to a network entity, information indicative of one or more parameters corresponding to a successive interference cancellation (SIC) capability of the apparatus, the SIC capability corresponding to support by the apparatus for SIC-based decoding; and receive, from the network entity, a downlink transmission configured based on the SIC capability of the apparatus.

In another example, a method for wireless communication is provided, the method including: transmitting, to a network entity, information indicative of one or more parameters corresponding to a successive interference cancellation (SIC) capability of the UE, the SIC capability corresponding to support by the UE for SIC-based decoding; and receiving, from the network entity, a downlink transmission configured based on the SIC capability of the UE.

In another example, a non-transitory computer-readable storage medium is provided comprising instructions stored thereon which, when executed by at least one processor, causes the at least one processor to: transmit, to a network entity, information indicative of one or more parameters corresponding to a successive interference cancellation (SIC) capability of the apparatus, the SIC capability corresponding to support by the apparatus for SIC-based decoding; and receive, from the network entity, a downlink transmission configured based on the SIC capability of the apparatus.

In another example, an apparatus is provided for wireless communication. The apparatus includes: means for transmitting, to a network entity, information indicative of one or more parameters corresponding to a successive interference cancellation (SIC) capability of the UE, the SIC capability corresponding to support by the UE for SIC-based decoding; and means for receiving, from the network entity, a downlink transmission configured based on the SIC capability of the UE.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating example multiple-input multiple-output (MIMO) configurations, including a first example MIMO configuration using dual codewords, a second example MIMO configuration using a single codeword, and a third example MIMO configuration using a single codeword with spatial coupling, in accordance with some examples;

FIG. 7 is a diagram illustrating example spatially coupled (SC) MIMO (SC-MIMO) configurations with two, three, or four spatial layers and a single codeword, in accordance with some examples;

FIG. 8 is a flow diagram illustrating an example of a process for wireless communication, in accordance with some examples; and

FIG. 9 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

A wireless device may support Multiple Input Multiple Output (MIMO) transmission schemes to perform transmission using multiple independent data streams (e.g., layers, also referred to as spatial layers) that may be transmitted simultaneously using different antennas or antenna ports of the wireless device. Multi-layer MIMO can be used to refer to spatial multiplexing of the multiple data streams onto a corresponding set of multiple transmission layers (e.g., spatial layers). In various wireless communication networks (e.g., 4G/LTE, 5G/NR, 6G, and beyond), communication links may use multiple-input multiple-output (MIMO) configurations and/or MIMO antenna technology, including spatial multiplexing, beamforming, and/or various other techniques for increasing transmit diversity. MIMO communications may use multiple antennas at both the transmitter (e.g., multiple Tx antennas) and at the receiver (e.g., multiple Rx antennas), with a plurality of different signal propagation paths between the different unique combinations of Tx antenna and Rx antenna pairs. MIMO channels can be represented using a channel matrix that corresponds to the respective spatial correlations between the different transmit and receive antennas of a MIMO system or channel, with the dimensions of the channel matrix indicative of the antenna configuration. For example, a 4×4 channel matrix can correspond to a 4×4 MIMO configuration with four transmit antennas and four receive antennas, etc.

In some examples, a wireless device configured for multi-layer MIMO transmission schemes may use multiple layers to transmit the coded bits of a single code block (CB). For example, a first portion of the CB can comprise a first subset of coded bits within the CB that are associated with transmission over a first layer, a second portion of the CB can comprise a second subset of coded bits within the CB that are associated with transmission over a second layer, etc. In some examples, wireless communication networks can perform wireless communications where a transport block (TB) is mapped over some, or all, of the respective carriers and/or spatial layers associated with a MIMO link. A TB can include a plurality of code blocks (CBs), where each CB is a subset of the TB. Transmission and reception can be performed at the TB level, the CB level, and/or a level of the data information represented within a CB (e.g., bit-level, symbol-level, etc.).

Multiple different transmission layers can be associated with the same CB, and each transmission layer may be associated with respective transmission parameters, channel conditions, etc. For example, different layers associated with the same CB can be configured with a different modulation coding scheme (MCS), based on the layer signal-to-noise ratio (SNR), among various other parameters or conditions. Different MCSs can correspond to different modulation orders for transmissions over the respective layers corresponding to the coded bits within a single CB. In some examples, different modulation orders per layer can also correspond to different symbol lengths for transmissions using a particular one of the multiple layers corresponding to a CB (e.g., where the symbol length refers to the number of coded bits mapped to each modulation symbol of the constellation diagram according to the MCS and modulation order, etc.).

As noted above, a TB can include a plurality of CBs, where each CB may be encoded separately for transmission. Transmission(s) corresponding to a spatial layer of a MIMO scheme (e.g., a particular spatial layer of the multiple spatial layers associated with the MIMO scheme, etc.) can be used for multiple encoded codewords and/or CBs. Transmission may be performed based on mapping the codewords and/or CBs to corresponding time-frequency resources, and mapping (e.g., within a spatial domain) across the respective spatial layers of the MIMO scheme. Different spatial layers of the multiple spatial layers of a MIMO scheme can be associated with different rates, capacities, etc., among various other parameters.

In some examples, MIMO may be configured for single-user (SU) operation (e.g., SU-MIMO) and/or can be configured for multi-user (MU) operation (e.g., MU-MIMO), where SU-MIMO corresponds to communications with a single UE or network device, and MU-MIMO can be used for simultaneous transmission to multiple UEs or network devices. Various codeword structures can be used for MIMO communications, based at least in part on the mapping between codewords and the spatial layers associated with a MIMO communication link. For example, the spatial layers of a MIMO communication link can correspond to the independent spatial transmission paths that can carry data streams through the wireless medium (e.g., each spatial layer of the MIMO communication link can correspond to a unique pair of transmit and receive antennas, etc.). The transmitting device can perform layer mapping to distribute portions of a signal to be transmitted across the different respective spatial layers of the MIMO communication link, with the layer mapping performed before precoding and transmission for each respective spatial layer using the corresponding Tx-Rx antenna's spatial transmission path. In SU-MIMO, the number of streams of information flow from a transport block (TB) can be equal to the number of spatial layers. In MU-MIMO, the number of streams may be equal to the total number of spatial layers across all users of the multiple users of an MU-MIMO communication link.

In some cases, a wireless communication network may implement a respective codeword mapped to each spatial layer of the multiple spatial layers of the MIMO communication link. For example, 4G/LTE networks may use up to two codewords transmitted in up to four spatial layers (e.g., such as for a 2×2 MIMO configuration, etc.). In codeword-to-layer mapping techniques, each codeword may be independently channel encoded and mapped to a separate spatial layer of the MIMO link. For example, a first codeword 0 (CW0) may be mapped to a first layer (e.g., Layer 0) of the MIMO spatial layers. A second codeword 1 (CW1) may be mapped to a second layer (e.g., Layer 1) of the MIMO spatial layers. Separate modulation, precoding, and layer mapping can be performed per codeword (e.g., per spatial layer associated with a different codeword, etc.). In some cases, codeword-to-layer mapping with two codewords (CWs) can also be referred to as dual CW MIMO, where the first codeword CW0 and the second codeword CW1 can be assigned different rates, and where hard selective interference cancellation (SIC) may be utilized.

In some examples, a spatially coupled MIMO (SC-MIMO) scheme can be implemented by a transmitter that performs mapping between codewords and spatial layers using a single codeword design with spatial coupling. A corresponding receiver of the SC-MIMO scheme can perform demapping based on SIC, where the receiver demodulates and decodes respective CBs across different spatial layers and time/frequency resources. Based on successful decoding of a first CB (e.g., a first CB0), the decoded CB0 can be subtracted and used to demodulate and decoded the next CB (e.g., CB1) that was transmitted on a different spatial layer while using the same time-frequency resources. Based on successfully demodulating and decoding the next CB1, the decoded CB1 can be subtracted and used to demodulate and decode the next CB (e.g., CB2), etc. SC-MIMO implementations using SIC to perform demapping by a receiver can be associated with increased complexity and longer decoding times than techniques such as linear minimum mean square error (LMMSE), among various others.

There is a need for systems and techniques that can be used to provide SC-MIMO with SIC or SIC-based demapping by an SC-MIMO receiver. There is a further need for systems and techniques that can be used to provide SIC or SIC-based demapping (e.g., for SC-MIMO receivers) with a reduced computational complexity and/or a shorter decoding time associated with the SIC or SIC-based demapping. There is a further need for systems and techniques that can be used to provide SC-MIMO using SIC decoding for receivers that are hardware-constrained or have relatively low computational complexity, and/or for receivers that are associated with one or more latency constraints or requirements, etc., one or more energy constraints or requirements, etc.

Systems, apparatuses, processes (also referred to as methods), and computer-readable media (collectively referred to as “systems and techniques”) are described herein that can be used to provide capability reporting for successive interference cancellation (SIC) capability information associated with a UE and/or other network device, network entity, etc., configured to perform spatially coupled MIMO transmission and/or reception. For example, the systems and techniques can be used to provide UE SIC capability reporting, including UE SIC capability reporting associated with SC-MIMO communications transmitted and/or received by the UE. In some cases, the systems and techniques can provide dynamic enablement and/or disablement of SIC for the UE, based at least in part on the UE SIC capability reporting information transmitted by the UE. In some cases, SIC for SC-MIMO may be dynamically enabled and/or disabled based on parameters that may include the number of CBs, the MCS order, the number of allocated time-frequency resources, etc., associated with an SC-MIMO communication between the UE and a network entity (e.g., base station, gNB, etc.).

In some cases, the SIC capability reporting information can be used to enable or disable SIC based on the decoding capabilities of the receiver. For example, UE SIC capability reporting information can be used to enable SIC in examples where the UE SIC capability indicates the UE has decoding capabilities to perform the SIC-based decoding within a maximum (e.g., threshold, configured value, etc.) decoding time. In some cases, UE SIC capability reporting information can be used to disable SIC in examples where the UE SIC capability indicates the UE does not have decoding capabilities to perform the SIC-based decoding within the maximum or threshold decoding time (e.g., disabling SIC based on SIC capability information indicative of a decoding time that exceeds the configured or threshold maximum decoding time, etc.).

In some examples, a UE can be configured to report SIC capability information indicative of the UE capability of supporting SIC based on a maximum number of CBs. For example, the UE can indicate a maximum number of CBs (e.g., per TB) that are supported by the UE to perform SIC. Based on the number of CBs for a transmission being within the threshold of the signaled maximum number of CBs for the UE, a network entity (e.g., base station, gNB, etc.) can enable SIC for the transmission. Based on the number of CBs for the transmission exceeding the threshold of the signaled maximum number of CBs for the UE, the network entity may disable SIC for the transmission. For example, a UE may report SIC capability information indicating the UE can support SIC if the number of CBs (e.g., per TB) is less than 200, or other values of the maximum number of supported CBs for the UE to perform SIC, etc.

In some cases, a UE can be configured to report a capability of supporting SIC based on a maximum time or decoding threshold. For example, the UE can indicate a maximum decoding time for supporting SIC by the UE. Decoding timelines where SIC decoding would exceed the decoding threshold indicated in the UE SIC capability information can cause the network entity to disable (e.g., not use) SIC. Decoding timelines where SIC decoding is within (e.g., does not exceed) the decoding threshold can cause the network entity to enable (e.g., use) SIC. In some examples, the UE SIC capability information can report the UE capability to support, or not support, SIC for decoding and/or demapping an SC-MIMO transmission, where the UE capability is based on a remaining energy or power information of the UE. For example, the UE capability can be indicative of a threshold amount of power or energy where the UE does not support SIC when the remaining or available power of the UE is below the threshold, and/or where the UE does support SIC when the remaining or available power of the UE exceeds the threshold, etc.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

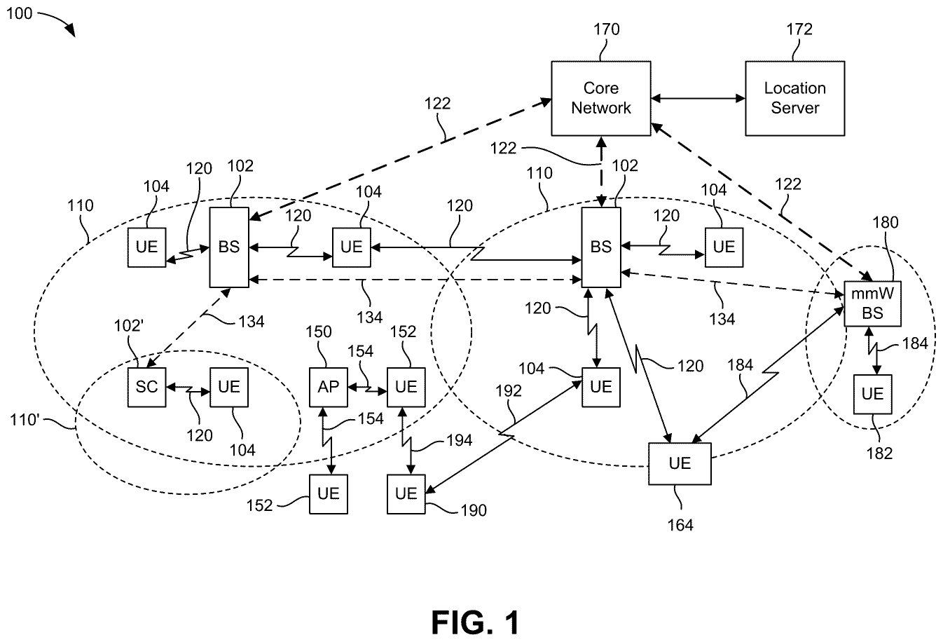

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network wireless communications system of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

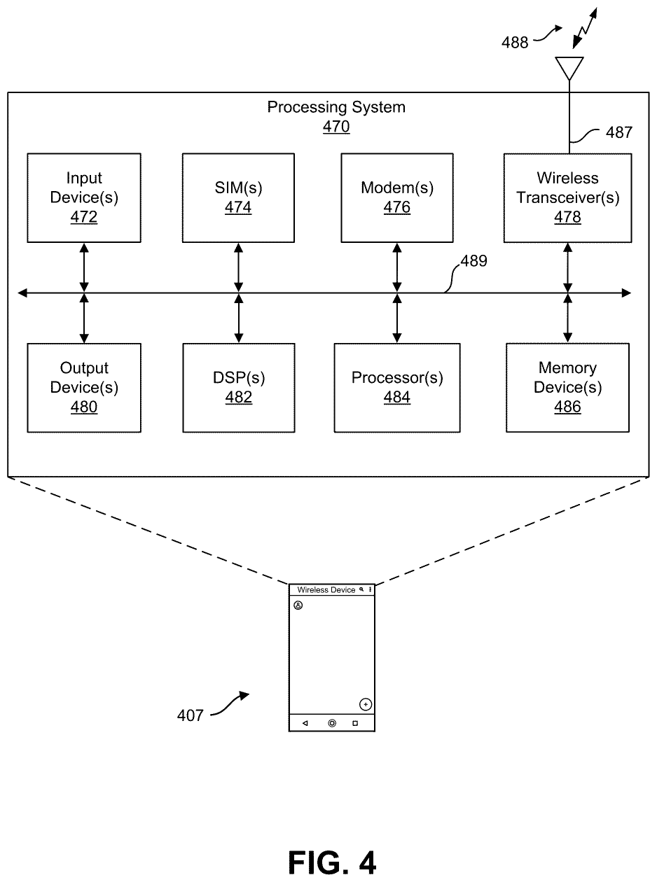

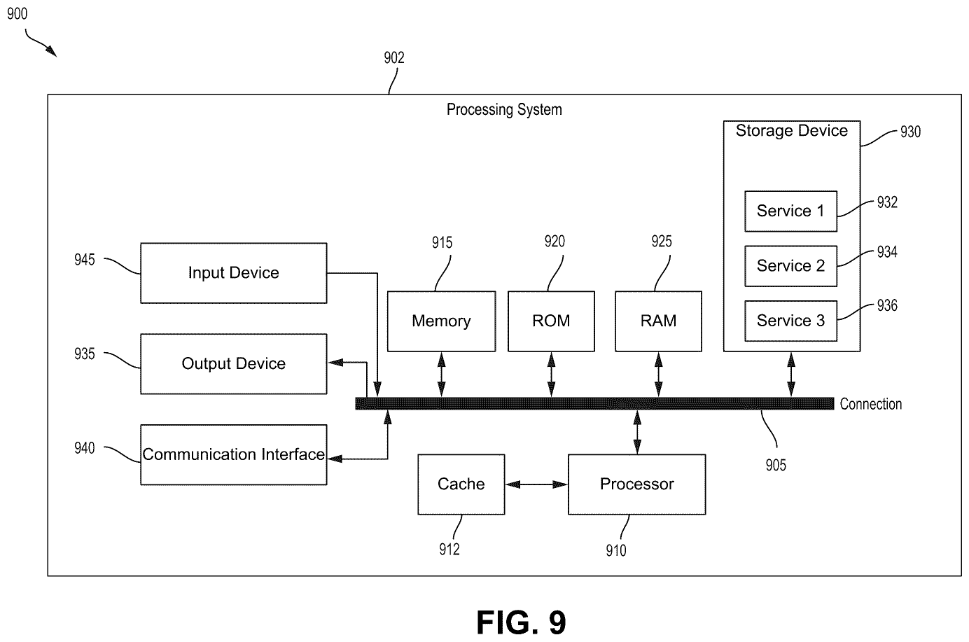

In some examples, the network entity 102 may include a processing system (e.g., such as the processing system 470 of FIG. 4 and/or the processing system 902 of FIG. 9, etc.). Similarly, the network entity 180 (e.g., a millimeter wave (mmW) base station, etc.) may include a respective processing system (e.g., such as the processing system 470 of FIG. 4 and/or the processing system 902 of FIG. 9, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’without interrupting the service on band ‘X’or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

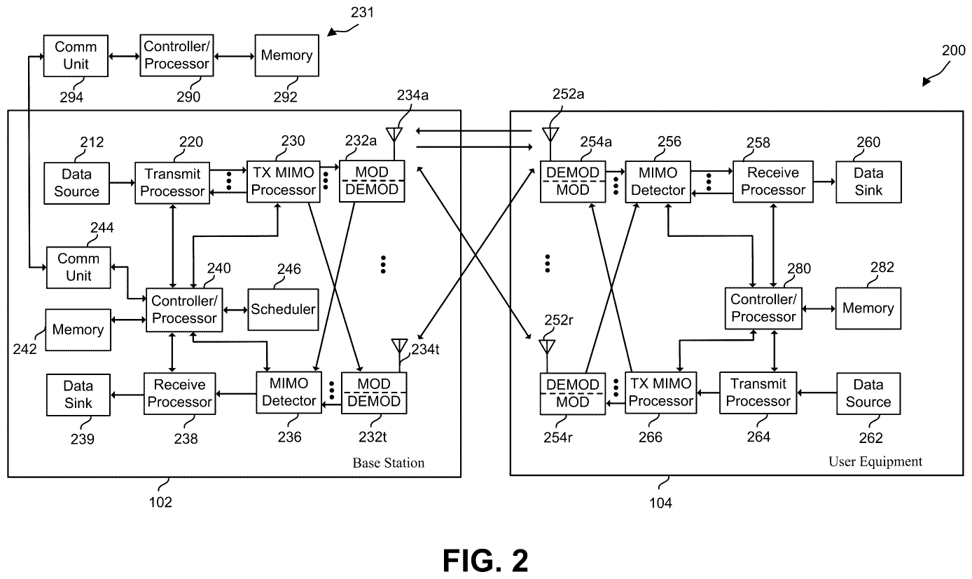

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit Uplink Control Information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

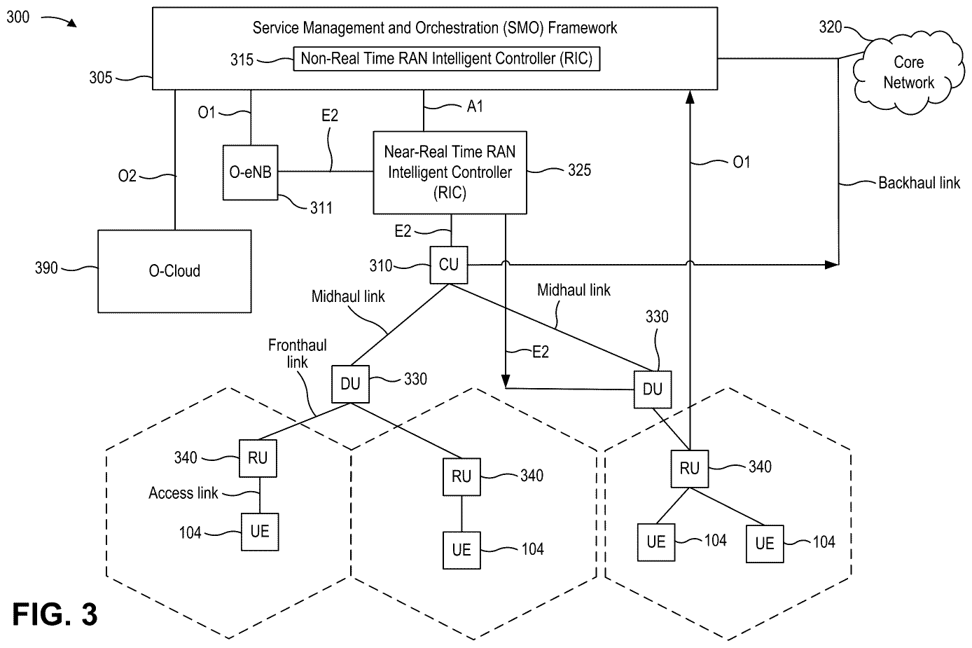

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 902 of FIG. 9 (e.g., and the processing system 902 of FIG. 9 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

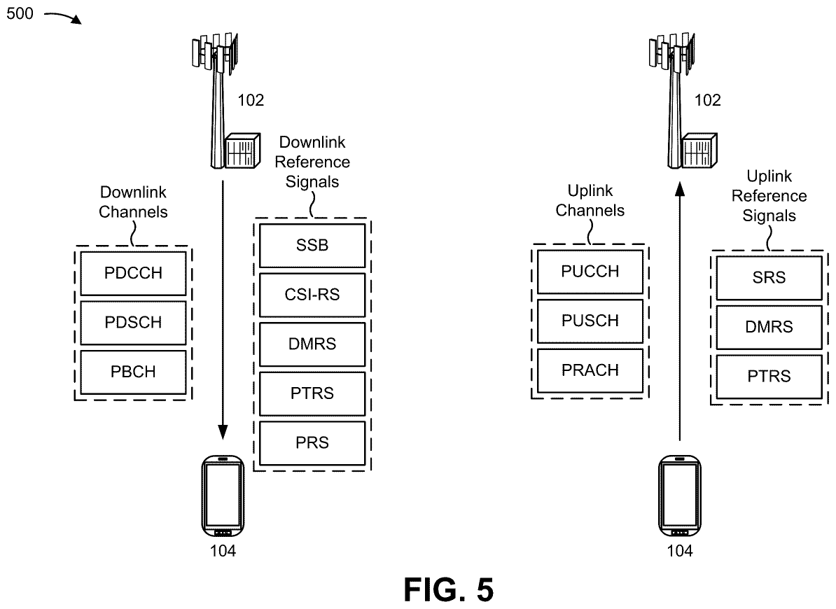

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

In some cases, a UE may receive a reference signal (e.g., a CSI-RS, an SSB, a DMRS, etc.) from a network entity (or another UE) and can report channel state feedback (CSF) to the network entity (or the other UE), where the CSF is determined based on measurements of the reference signal received at the UE. In some cases, a UE may also transmit a reference signal (e.g., CSI-RS, DMRS, PT-RS, SRS, etc.), and a network entity (or another UE) may determine characteristics associated with the channel based on measurements of the received reference signal.

As noted above, systems and techniques are provided herein that can be used to provide dynamic reporting of successive interference cancellation (SIC) capabilities of a UE, where the SIC capabilities of the UE are associated with using SIC to perform decoding and/or demapping of information received over a spatially coupled (SC) multiple-input multiple-output (SC-MIMO) transmission link with a plurality of spatial layers. For example, the SIC capabilities of the UE can be associated with using SIC to perform decoding and/or demapping, where the SIC capabilities correspond to the UE supporting or not supporting the use of SIC, based on one or more of SIC capability information corresponding to a number of CBs, a TB length, an MCS index, spatial layers, decoding time and/or latency, energy levels, etc., for an SC-MIMO reception by the UE.

As noted above, a TB can include a plurality of CBs, where each CB may be encoded separately for transmission. Transmission(s) corresponding to a spatial layer of a MIMO scheme (e.g., a particular spatial layer of the multiple spatial layers associated with the MIMO scheme, etc.) can be used for multiple encoded codewords and/or CBs. Transmission may be performed based on mapping the codewords and/or CBs to corresponding time-frequency resources, and mapping (e.g., within a spatial domain) across the respective spatial layers of the MIMO scheme. Different spatial layers of the multiple spatial layers of a MIMO scheme can be associated with different rates, capacities, etc., among various other parameters.

In some cases, spatially coupled MIMO (SC-MIMO) can be implemented using a mapping between codewords and spatial layers of the SC-MIMO scheme. For example, a codeword (CW) can be mapped to particular time-frequency resources (e.g., a mapping in the time-frequency domain), and may be mapped to a particular spatial layer (e.g., a mapping in the spatial domain). Different mappings between codewords, time-frequency resources, and spatial layers can correspond to differences in interference between codewords, throughput, cross-layer diversity, etc. Different mappings may also be associated with different demodulation and/or decoding schemes and/or techniques implemented by the SC-MIMO receiver that receives an SC-MIMO transmission using a particular codeword to spatial layer mapping scheme.

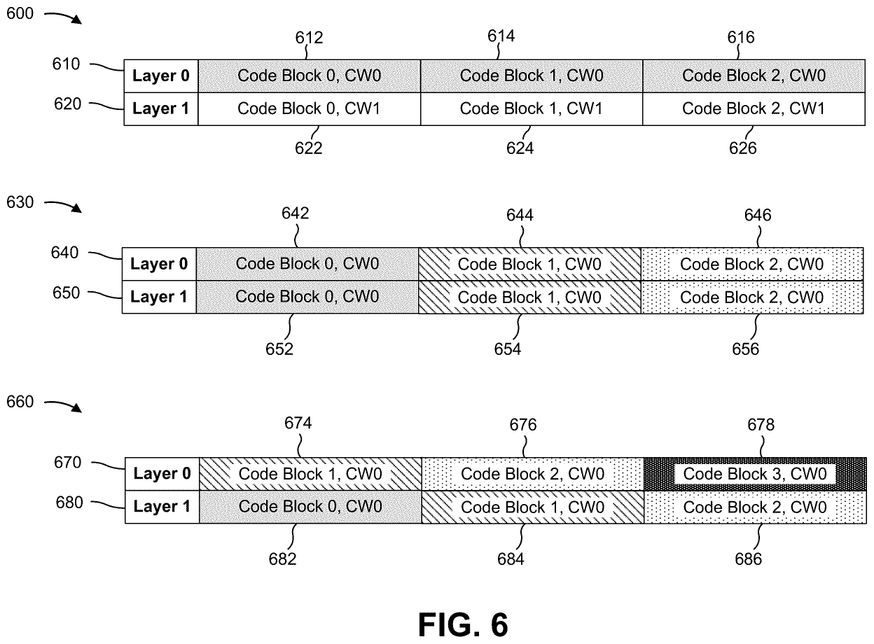

For example, FIG. 6 is a diagram illustrating example MIMO configurations with different respective mappings between codewords and spatial layers. A first example MIMO configuration 600 corresponds to dual codeword MIMO for two layer transmission, using a first spatial layer (e.g., Layer 0) 610 and a second spatial layer (e.g., Layer 1) 620. In some aspects, the first example MIMO configuration 600 may also be referred to as a dual CW MIMO configuration 600, with the dual CWs corresponding to a first codeword CW0 and a second codeword CW1. In the dual CW MIMO configuration 600, CW0 and CW1 are assigned different rates and hard-SIC may be applied.

The dual CW MIMO configuration 600 is represented as a mapping of codewords in the time-frequency domain (e.g., corresponding to the horizontal dimension, left-right direction of FIG. 6) and in the spatial domain (e.g., corresponding to the vertical dimension, up-down direction between spatial layers 610 and 620). The two codewords of the dual CW MIMO configuration 600 are CW0 and CW1, and the two codewords CW0 and CW1 are mapped for a plurality of CBs (e.g., CB0, CB1, CB2, . . . , etc.). For each CB of the plurality of CBs, the dual CW MIMO configuration 600 corresponds to mapping each CB to all of the spatial layers in the same time frequency resources.

For example, Code Block 0, CW0 612 is mapped to spatial Layer 0 610 on a first set of time-frequency resources, and Code Block 0, CW1 622 is mapped to spatial Layer 1 620, also on the first set of time-frequency resources. For CB0, the first codeword CW0 612 and the second codeword CW1 622 are mapped to the same set of time-frequency resources, in different respective spatial layers (e.g., Layer 0 610 for CW0 612, and Layer 1 620 for CW1 622).

For Code Block 1, CW0 614 is mapped to spatial Layer 0 610 on a second set of time-frequency resources, and CW1 624 is mapped to spatial Layer 1 620, also on the second set of time-frequency resources. For CB1, the first codeword CW0 614 and the second codeword CW1 624 are mapped to the same second set of time-frequency resources, in different respective spatial layers (e.g., spatial Layer 0 610 for CW0 614, and spatial Layer 1 620 for CW1 624).

For Code Block 2, CW0 616 is mapped to spatial Layer 0 610 on a third set of time-frequency resources, and CW1 626 is mapped to spatial Layer 1 620, also on the third set of time-frequency resources. For CB2, the first codeword CW0 616 and the second codeword CW1 626 are mapped to the same third set of time-frequency resources, in different respective spatial layers (e.g., spatial Layer 0 610 for CW0 616, and spatial Layer 1 620 for CW1 626).

In some cases, 4G/LTE networks may be configured to use a dual CW MIMO design, such as the dual CW MIMO configuration 600. In the dual CW MIMO configuration 600, each spatial layer is mapped to the same codeword, for each respective CB of the plurality of CBs. For example, spatial layer 610 is mapped to the codeword CW0 for CB0 (e.g., CB0, CW0 612), CB1 (e.g., CB1, CW0 614), CB2 (e.g., CB2, CW0 616, . . . , etc. Spatial layer 620 is mapped to the codeword CW1 for CB0 (e.g., CB0, CW1 622), CB1 (e.g., CB1, CW1 624), CB2 (e.g., CB2, CW1 626), . . . , etc.

In another illustrative example, a second example MIMO configuration 630 can correspond to a single CW design with irregular low-density parity check (LDPC) error-correcting codes. The second example MIMO configuration 630 may also be referred to as single CW MIMO with irregular LDPC, and/or may be referred to as NR single CW (e.g., based on 5G NR networks supporting and/or using MIMO schemes corresponding to the example MIMO configuration 630). In the example single CW MIMO configuration 630 with irregular LDPC, one LDPC-encoded codeword may be transmitted over multiple spatial layers.

For example, the multiple spatial layers can include a first spatial layer 0 640 and a second spatial layer 1 650, which can correspond to the first spatial layer 0 610 and the second spatial layer 1 620 (respectively) of the dual CW MIMO configuration 600. For single CW MIMO performed over two spatial layers, one LDPC-encoded codeword (e.g., the same, single CW) is transmitted over each of the spatial layers 640 and 650. The LDPC-encoded codeword can be an LDPC-encoded codeword CW0. For example, the codeword CW0 is transmitted over spatial layer 0 640 as a first CB0, CW0 portion 642, and is transmitted over spatial layer 1 650 as a second CB0, CW0 portion 652.

For the next code block, CB1, the same codeword CW0 is transmitted over spatial layer 0 640 as a first CB1, CW0 portion 644 and is transmitted over spatial layer 1 650 as a second CB1, CW0 portion 654. For the next code block, CB2, the same codeword CW0 is transmitted over spatial layer 0 640 as a first CB2, CW0 portion 646, and is transmitted over spatial layer 1 650 as a second CB2, CW0 portion 656.

In some cases, the single CW MIMO configuration 630 with irregular LDPC can use iterative demodulation and/or decoding at the receiver, where the iterative demodulation and/or decoding is performed by the receiver across the multiple spatial layers (e.g., spatial layer 0 640 and spatial layer 1 650, etc.) for best performance. In examples where the single CW MIMO Configuration 630 with irregular LDPC is used in with the 5G NR LDPC error correcting code(s), the 5G NR LDPC may not support the iterative demodulation and/or decoding that corresponds to the best performance at the receiver. For example, LDPC in NR is irregular, with non-uniform variable check node degrees. When the one LDPC-encoded codeword (e.g., CW0) is transmitted over the multiple spatial layers (e.g., spatial layer 0 640 and spatial layer 1 650), one decoder receives a signal from both spatial layers. The decoder may be configured to perform decoding with separate stream decoding, and without iterative demodulation and/or decoding, as the irregular LDPC corresponds to non-uniform bit distributions that are not suitable for iterative demodulation and decoding. The single CW MIMO configuration 630 introduces spatial diversity, based on mapping the LDPC-encoded CW0 across each spatial layer across the spatial domain (e.g., layer 0 640 and layer 1 650). The single CW MIMO configuration 630 does not introduce time-frequency diversity, based on the same time-frequency resources being used for the spatial layer 0 640 and spatial layer 1 650 transmissions of CW0 for each respective code block CB0, CB1, CB2, . . . , etc.

In a third example MIMO configuration 660, a single CW design can be used with the single codeword CW0 transmitted for each code block (e.g., CB0, CB1, CB2, . . . , etc.) across multiple spatial layers (e.g., the two spatial layer spatial layer 0 670 and spatial layer 1 680), and with the transmissions of the codeword CW0 performed for each CB based on using different time-frequency resources for each spatial layer. For example, the third MIMO configuration 660 can be a single CW design with spatial coupling. A single CW rate can be selected and/or implemented to match the collective channel quality across the multiple spatial layers (e.g., spatial layer 0 670, spatial layer 1 680, etc.). A code structure for the single CW design with spatial coupling used for the third example MIMO configuration 660 may be based on the Diagonal Bell Labs Layered Space Time (D-BLAST) type, in some examples. The spatial coupling associated with the single CW design MIMO configuration 660 can be associated with a single codeword (e.g., CW0) that captures more channel realizations than a single codeword used with the irregular LDPC design associated with the single CW MIMO configuration 630.

For example, for each code block of a sequence of code blocks CB0, CB1, CB2, . . . , etc. the single codeword CW0 is used for transmission on each of the multiple spatial layers, using a different set of time-frequency resources for the transmission of the CW0for a CB on each spatial layer. A first set of time-frequency resources can be used to transmit a first CB1, CW0 portion 674. A second set of time-frequency resources can be used to transmit a second CB1, CW0 portion 684. The use of different time-frequency resources for the first portion 674 and the second portion 684 of the CB1, CW0 transmission on the multiple spatial layers layer 0 670 and layer 1 680 can correspond to increased diversity in the time domain and/or the frequency domain. The first set of time-frequency resources can be used to transmit the first CB1, CW0 portion 674 on the first spatial layer 0 670. The first set of time-frequency resources can additionally be used to transmit a CB0, CW0 portion 682 on the second spatial layer 1 680.

The second set of time-frequency resources can be used to transmit a first CB2, CW0 portion 676 on the first spatial layer 0 670, and can be used to transmit the second CB1, CW0 portion 684 (e.g., as noted above) on the second spatial layer 1 680. The third set of time-frequency resources can be used to transmit a first CB3, CW0 portion 678 on the first spatial layer 0 670, and can be used to transmit a second CB2, CW0 portion 686 on the second spatial layer 1 680.

In some cases, decoding for the single CW MIMO configuration 630 with irregular LDPC may be lower in computational complexity and/or decoding time than the decoding performed for the single CW with spatial coupling MIMO configuration 660. For example, the single CW MIMO configuration 630 with irregular LDPC can perform decoding of the respective portion of each CB, CW0 transmission based on the same time-frequency resources being used for the respective portion of the CB, CW0 portion mapped across the multiple spatial layers. In the spatially coupled single CW MIMO configuration 660, the respective portions of each CB, CW0 transmission are spread over different time-frequency resources across the multiple spatial layers.

For example, to decode the CB1, CW0 portion 674 received in the first set of time-frequency resources, the receiver must first decode the CB0, CW0 portion 682 on spatial layer 1 680. The decoded CB0, CW0 portion 682 can then be subtracted from the total signal reception on the first set of time-frequency resources, to obtain the encoded CB1, CW0 portion 674 for decoding. In some cases, removing the decoded CB0, CW0 portion 682 corresponding to spatial layer 1 680 on the first time-frequency resources can correspond to clearing or cancelling interference on the encoded CB1, CW0 portion corresponding to spatial layer 0 670 for the same, first time-frequency resources.

In the second set of time-frequency resources, the second CB1, CW0 portion 684 on spatial layer 1 680 must first be decoded and subtracted from the received signal to obtain the encoded first CB 2, CW0 portion 676 received on spatial layer 0 670 for the same, second set of time-frequency resources. In the third set of time-frequency resources, the second CB2, CW0 portion 686 must first be decoded and subtracted from the received signal to obtain the encoded first CB3, CW0 portion 678 received on spatial layer 0 670 for the same, third set of time-frequency resources. The decoding scheme noted above can be referred to as successive interference cancellation (SIC) and/or SIC-based decoding for spatially coupled MIMO, etc.

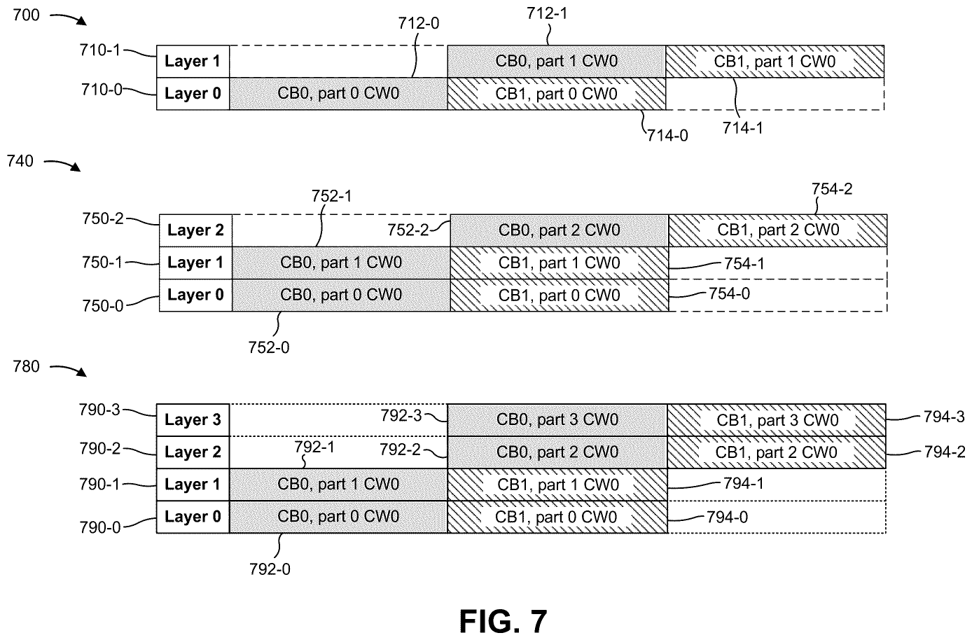

In some examples, a spatially coupled MIMO (SC-MIMO) scheme can be implemented by a transmitter that performs mapping between codewords and spatial layers using a single codeword design with spatial coupling. A corresponding receiver of the SC-MIMO scheme can perform demapping based on SIC, where the receiver demodulates and decodes respective CBs across different spatial layers and time/frequency resources. Based on successful decoding of a first CB (e.g., a first CB0), the decoded CB0 can be subtracted and used to demodulate and decoded the next CB (e.g., CB1) that was transmitted on a different spatial layer while using the same time-frequency resources. Based on successfully demodulating and decoding the next CB1, the decoded CB1 can be subtracted and used to demodulate and decode the next CB (e.g., CB2), etc. SC-MIMO implementations using SIC to perform demapping by a receiver can be associated with increased complexity and longer decoding times than techniques such as linear minimum mean square error (LMMSE), among various others. For example, FIG. 7 is a diagram illustrating example spatially coupled (SC) MIMO (SC-MIMO) configurations with two, three, or four spatial layers and a single codeword, in accordance with some examples. For example, a first SC-MIMO configuration 700 corresponds to a set of multiple spatial layers comprising a first spatial layer 0 710-0 and a second spatial layer 1 710-1. In some aspects, the first SC-MIMO configuration 700 can also be referred to as a two-layer SC-MIMO configuration 700.

A second SC-MIMO configuration 740 corresponds to a set of multiple spatial layers comprising a first spatial layer 0 750-0, a second spatial layer 1 750-1, and a third spatial layer 2 750-2. In some aspects, the second SC-MIMO configuration 740 can also be referred to as a three-layer SC-MIMO configuration 740. In some examples, the first spatial layer 0 750-0 can be the same as or similar to the first spatial layer 0 710-0, and/or the second spatial layer 1 750-1 can be the same as or similar to the second spatial layer 1 710-1, etc.

A third SC-MIMO configuration 780 corresponds to a set of multiple spatial layers comprising a first spatial layer 0 790-0, a second spatial layer 1 790-1, a third spatial layer 2 790-2, and a fourth spatial layer 3 790-3. In some aspects, the third SC-MIMO configuration 780 can also be referred to as a four-layer SC-MIMO configuration 780. In some examples, the first spatial layer 0 790-0 can be the same as or similar to the first spatial layer 0 710-0 and/or the first spatial layer 0 750-0. The second spatial layer 1 790-1 can be the same as or similar to the second spatial layer 1 710-1 and/or the second spatial layer 1 750-1. The third spatial layer 2 790-2 can be the same as or similar to the third spatial layer 2 750-2.

In the example SC MIMO configurations 700, 740, and 780 of FIG. 7, mapping can correspond to a single codeword design with spatial coupling across the multiple spatial layers. For example, the single codeword can be the codeword CW0, which is used for each code block of a plurality of code blocks (e.g., CB0, CB1, CB2, . . . , etc.) and for each spatial layer of the multiple spatial layers (e.g., the two spatial layers 710-0 and 710-1 of the two-layer SC-MIMO configuration 700; the three spatial layers 750-0, 750-1, 750-2 of the three-layer SC-MIMO configuration 740; the four spatial layers 790-0, 790-1, 790-2, 790-3 of the four-layer SC-MIMO configuration 780; etc.).

In some aspects, the CW rate can be selected to match the channel quality across the different respective spatial layers of each multi-layer SC-MIMO configuration (e.g., two-layer SC-MIMO configuration 700, three-layer SC-MIMO configuration 740, four-layer SC-MIMO configuration 780, etc.). The mapping structure between the code block CW0 portions across the multiple spatial layers can be based on the D-BLAST scheme, and/or may be the same as or similar to the mapping of the spatially coupled single CW MIMO configuration 660 of FIG. 6, etc.

For example, the two-layer SC-MIMO configuration 700 can map a CB0, part 0 CW0 portion 712-0 to a first set of time-frequency resources and the first spatial layer 710-0. The CB0, part 1 CW0 portion 712-1 can be mapped to a second set of time-frequency resources and the second spatial layer 710-1. A CB1, part 0 CW0 portion 714-0 can be mapped to the second set of time-frequency resources and the first spatial layer 710-0. The CB1, part 1 CW0 portion 714-1 can be mapped to a third set of time-frequency resources and the second spatial layer 710-1.

In another example, the three-layer SC-MIMO configuration 740 can map three CW0 portions across the three spatial layers 750-0, 750-1, 750-2 for each respective code block. For example, a CB0, part 0 CW0 portion 752-0 can be mapped to the first spatial layer 750-0 in a first set of time-frequency resources. The CB0, part 1 CW0 portion 752-1 can be mapped to the second spatial layer 750-1 in the same, first set of time-frequency resources. The CB0, part 2 CW0 portion 752-2 can be mapped to the third spatial layer 750-2 in a second set of time-frequency resources. The second set of time-frequency resources are also used to map a CB1, part 0 CW0 portion 754-0 to the first spatial layer 750-0, and to map the CB1, part 1 CW0 portion 754-1 to the second spatial layer 750-1. The third CB1, part 2 CW0 portion 754-2 is mapped to the third spatial layer 750-2 using a third set of time-frequency resources.

In another example, the four-layer SC-MIMO configuration 780 can map four CW0 portions across the four spatial layers 790-0, 790-1, 790-2, 790-3 for each respective code block. For example, a CB0, part 0 CW0 portion 792-0 is mapped to the first spatial layer 790-0 using a first set of time-frequency resources, and the CB0, part 1 CW0 portion 792-1 is mapped to the second spatial layer 790-1 also using the first set of time-frequency resources. The remaining third CB0, part 2 CW0 portion 792-2 and the fourth CB0, part 3 CW0 portion 792-3 are mapped to the third spatial layer 790-2 and the fourth spatial layer 790-3 (respectively) using a second set of time-frequency resources.

The second set of time-frequency resources are also used to map a first CB1, part 0 CW0 portion 794-0 to the first spatial layer 790-0 and to map a second CB1, part 1 CW0 portion 794-1 to the second spatial layer 790-1. The remaining third CB1, part 2 CW0 portion 794-2 and the fourth CB1, part 3 CW0 portion 794-3 are mapped to the third spatial layer 790-2 and the fourth spatial layer 790-3 (respectively) using a third set of time-frequency resources.

In some examples, demapping for an SC-MIMO configuration (e.g., two-layer SC-MIMO configuration 700, three-layer SC-MIMO configuration 740, four-layer SC-MIMO configuration 780, etc.). can be performed based on successive interference cancellation (SIC). For example, CB0 is demodulated and decoded and in response to successful decoding, CB0 is subtracted to obtain the modulated and encoded CB1 signal portion(s). CB1 is then demodulated and decoded, and in response to successful decoding of CB1, the decoded CB1 is then subtracted to obtain the modulated and encoded CB2 signal portion(s), etc.

As noted above, SC-MIMO configurations where SIC is used to perform demapping by a receiver can be associated with increased complexity and longer decoding times than techniques such as linear minimum mean square error (LMMSE), among various others. For receivers that are hardware-constrained and/or associated with various hardware limitations, and/or receivers with one or more latency constraints, and/or receivers with limited power or energy storage (e.g., UEs, mobile devices, etc.), the relative complexity of SC-MIMO decoding using SIC can correspond to the use of SIC being unsuitable for use by such receivers.

In one illustrative example, the systems and techniques provided herein can be used to provide SIC capability reporting indicative of one or more parameters associated with a UE and/or associated with performing or implementing SIC for decoding or demapping SC-MIMO by the UE. For example, the systems and techniques can be used to provide UE SIC capability reporting, including UE SIC capability reporting associated with SC-MIMO communications transmitted and/or received by the UE. In some cases, the systems and techniques can provide dynamic enablement and/or disablement of SIC for the UE, based at least in part on the UE SIC capability reporting information transmitted by the UE. In some cases, SIC for SC-MIMO may be dynamically enabled and/or disabled based on parameters that may include the number of CBs, the MCS order, the number of allocated time-frequency resources, etc., associated with an SC-MIMO communication between the UE and a network entity (e.g., base station, gNB, etc.).

In some cases, the SIC capability reporting information can be used to enable or disable SIC based on the decoding capabilities of the receiver. For example, UE SIC capability reporting information can be used to enable SIC in examples where the UE SIC capability indicates the UE has decoding capabilities to perform the SIC-based decoding within a maximum (e.g., threshold, configured value, etc.) decoding time. In some cases, UE SIC capability reporting information can be used to disable SIC in examples where the UE SIC capability indicates the UE does not have decoding capabilities to perform the SIC-based decoding within the maximum or threshold decoding time (e.g., disabling SIC based on SIC capability information indicative of a decoding time that exceeds the configured or threshold maximum decoding time, etc.). In some examples, a UE can be configured to report SIC capability information indicative of the UE capability of supporting SIC based on a maximum number of CBs. For example, the UE can indicate a maximum number of CBs (e.g., per TB) that are supported by the UE to perform SIC. Based on the number of CBs for a transmission being within the threshold of the signaled maximum number of CBs for the UE, a network entity (e.g., base station, gNB, etc.) can enable SIC for the transmission. Based on the number of CBs for the transmission exceeding the threshold of the signaled maximum number of CBs for the UE, the network entity may disable SIC for the transmission. For example, a UE may report SIC capability information indicating the UE can support SIC if the number of CBs (e.g., per TB) is less than 200, or other values of the maximum number of supported CBs for the UE to perform SIC, etc.

In some aspects, UE SIC capability information can be reported from a UE to a network entity (e.g., base station, gNB, etc.). The network entity can use the UE SIC capability information to determine the SIC capabilities for the UE. For example, in some cases the network entity can use the SIC capability information of the UE to determine one or more scenarios or circumstances where the UE supports, or does not support, the use of SIC for SC-MIMO. The network entity can dynamically adapt one or more SC-MIMO transmissions from the network entity to the UE based on the SIC capability information. For example, based on the SIC capability information indicating a scenario where the UE supports SIC, the network entity can perform SC-MIMO transmission to the UE for SIC decoding to be performed by the UE. Based on the SIC capability information indicating a scenario where the UE does not support SIC, the network entity can perform transmission with SIC disabled for the UE.

In some aspects, the UE can be configured to report information indicative of the UE capability to support SIC, where the SIC capability information is indicative of one or more thresholds for supporting or not supporting SIC. For example, the SIC capability information can indicate a corresponding threshold value for one or more parameters of the UE and/or parameters of the transmission. In some examples, for transmissions that would exceed the indicated threshold value for UE SIC capability, the network entity can determine the UE does not support SIC, and the network entity can disable SIC and/or can perform the transmission without SIC. In some cases, for transmissions that are below the indicated threshold value for UE SIC capability, the network entity can determine the UE does support SIC, and the network entity can enable SIC and/or can perform the transmission with SIC at the UE.

In some cases, parameter values that exceed the indicated threshold value for the parameter as indicated in the UE SIC capability information reported by the UE can correspond to the UE supporting SIC and the network entity enabling SIC, and parameter values that are within the indicated threshold value can correspond to the UE not supporting SIC and the network entity disabling SIC.

In another example, parameter values that exceed the indicated threshold value for the parameter as indicated in the UE SIC capability information reported by the UE can correspond to the UE not supporting SIC and the network entity disabling SIC, and parameter values that are within the indicated threshold value can correspond to the UE supporting SIC and the network entity enabling SIC.

In some cases, the UE can report capability information indicative of a maximum number of CBs for which the UE supports SIC for SC-MIMO. For example, UE SIC capability information indicative of a threshold value of 200 CBs can correspond to the UE supporting SIC for TBs including fewer than 200 CBs and/or for TBs including 200 CBs or less, and the UE not supporting SIC for TBs including more than 200 CBs.

The UE SIC capability information can be indicative of threshold values for one or more PHY-layer quantities or parameters, including the number of CBs (e.g., as noted above), which may be the number of CBs per TB, etc. The UE SIC capability information can be indicative of threshold values for one or more PHY-layer quantities or parameters including the number of CBs; the TB length (e.g., corresponding to UE support for SIC for TBs less than or equal to the threshold TB length, and the UE not supporting SIC for TBs greater than the threshold TB length); the number of allocated time-frequency resources (e.g., corresponding to the UE supporting SIC for allocated time-frequency resources less than or equal to the threshold number and not supporting SIC for allocated time-frequency resources greater than the threshold number, or vice versa); the MCS index (e.g., corresponding to the UE supporting SIC for MCS index values less than or equal to the indicated threshold value for the MCS index, and the UE not supporting SIC for MCS index values greater than the indicated threshold value, or vice versa); and/or the number of spatial layers included in the multiple spatial layers of the SC-MIMO configuration, scheme, communication link, etc. (e.g., corresponding to the UE supporting SIC for SC-MIMO with a number of spatial layers less than or equal to the indicated threshold number of spatial layers, and the UE not supporting Sic for SC-MIMO with a number of spatial layers greater than the indicated threshold number of spatial layers, or vice versa); etc.

In some cases, the UE SIC capability information can be reported and/or signaled within Uplink Control Information (UCI) transmitted from the UE to a network entity. In some cases, the UE can send information indicative of an initial UE SIC capability information, and may later send information indicative of one or more updates to the UE SIC capability information, where the one or more updates may increase or decrease one or more of the threshold parameter values for SIC support as indicated in the initial UE SIC capability information. In some examples, the UE SIC capability information can be reported or signaled within a PUSCH payload from the UE to the network entity, and or a channel quality indicator (CQI) signaled form the UE to the network entity, etc.

In another illustrative example, the UE SIC capability information can be indicative of the UE capability to support SIC based on a maximum and/or threshold amount of time. For example, the UE SIC capability information can indicate a maximum decoding time within which the UE supports SIC, and beyond which the UE does not support SIC. In some examples, the UE SIC capability information can indicate a maximum allowed decoding timeline equal to one millisecond (1 ms), where the UE may support SIC if the decoding timeline allows a processing delay of up to 1 ms, and where the UE does not support SIC if the decoding timeline exceeds the maximum indicated threshold of 1 ms. In some cases, the UE SIC capability information can indicate a maximum latency for decoding within which the UE supports SIC. A decoding timeline with an estimated latency that exceeds the indicated maximum latency value for the UE SIC capability can correspond to the UE not supporting SIC. A decoding timeline with an estimated latency that is within (e.g., less than or equal to) the indicated maximum latency value for the UE SIC capability can correspond to the UE supporting SIC. In some cases, the UE SIC capability information indicative of a maximum latency and/or maximum decoding time for the decoding timeline can be indicated using the UCI and/or the CQI and/or a PUSCH payload transmitted from the UE to the network entity.

In another example, the UE SIC capability information can be indicative of the UE capability to support SIC based on a remaining energy storage of the UE. For example, the UE SIC capability information can indicate a threshold energy level above which the UE supports SIC, and below which the UE does not support SIC. In one illustrative example, the UE SIC capability information can indicate a threshold energy level value of 1 watt (W), corresponding to the UE supporting SIC when the UE energy level is above the threshold value of 1 W, and the UE not supporting SIC when the UE energy level is below the threshold value of 1 W. In some cases, the UE SIC capability information indicative of a remaining or available energy level threshold value for SIC support can be indicated using the UCI and/or the CQI and/or a PUSCH payload transmitted from the UE to the network entity. In some aspects, the remaining energy or power associated with the UE and/or the UE SIC capability information reported can be based on one or more power headroom reports (PHRs) of the UE. For example, the UE may transmit one or more PHRs to the network entity, which the network entity can use to determine the remaining energy or power available to the UE, and compare the remaining energy or power available form the PHR of the UE to the indicated threshold value from the UE SIC capability report to determine whether the UE can support SIC or if the UE does not support SIC for a future or scheduled transmission from the network entity to the UE.

In one illustrative example, the UE can report UE SIC capability information indicative of the UE supporting or not supporting SIC for various scenarios corresponding to one or more functions of multiple threshold parameter values. For example, the UE capability to support SIC may be a function of multiple parameter values, with the threshold for supporting or not supporting SIC determined as a combination (e.g., function) of the multiple parameters and corresponding thresholds indicated by the UE SIC capability information. In some examples, the UE SIC capability may be a function of the remaining power at the UE and the number of CBs included in each TB. For higher (e.g., larger) values of the remaining power available at the UE, the UE SIC capability can support SIC for a relatively larger number of CBs. For lower (e.g., smaller) values of the remaining power available at the UE, the UE SIC capability may support SIC for a relatively smaller number of CBs. In another example, the UE SIC capability can use a first threshold for the maximum number of CBs for the UE to support SIC when the remaining power available at the UE is above an indicated threshold, and may use a second (lower) threshold for the maximum number of CBs for the UE to support SIC when the remaining power available at the UE is below the indicated threshold for the remaining power parameter of the UE SIC capability information reported to the network entity, etc.

UE SIC capability reporting indicative of combined parameter thresholds multi-variable functions for determining UE support (or lack of support) for SIC can be indicated and/or signaled to a network entity using UCI, CQI, and/or a PUSCH payload transmitted from the UE to the network entity.

In some cases, the UE can be configured to locally compute a function (e.g., an SIC support function, etc.) denoted by f, where f:Θ→. Here, the term Θ represents a multi-dimensional space, with dimensions corresponding to one or more parameters associated with the UE SIC support, as noted above. For example, the term Θ can represent a multi-dimensional space, with dimensions corresponding to the TB length, the number of allocated time-frequency resources, the MCS index, the number of spatial layers for SC-MIMO, a maximum decoding time or timeline of the UE, a maximum allowed latency for the UE decoding time or timeline, and/or a remaining energy available for the UE, etc. In some aspects, the locally computed SIC support function f can be different for each respective UE of a plurality of UEs configured to perform SIC capability reporting to a network entity.

In one illustrative example, a particular UE can perform SIC capability reporting with a network entity based on initially signaling to the network entity the function Θ corresponding to (e.g., locally computed, determined, and/or generated, etc.) for the particular UE. After the initial signaling of the SIC support function f for the particular UE, the network entity can compare respective values for the variables or parameters of the UE that are each encoded by and represented within one or more dimensions of the multi-dimensional space Θ, with a result of the comparison indicating that the UE supports SIC or does not support SIC. In some examples, the UE can indicate the corresponding SIC support function f for the UE (e.g. locally computed and/or generated by the UE, etc.) using UCI, CQI, and/or a PUSHC payload transmitted from the UE to the network entity. In some aspects, the SIC support function f corresponding to the SIC capability and/or the SIC support for a particular UE may comprise a table or other data structure that indicates mappings between different combinations of parameters (e.g., dimensions in Θ) and respective parameter threshold values, with an indication of the UE supporting or not supporting SIC for each particular combination of the plurality of different combinations mapped in the table or other data structure storing the SIC support function f for the UE.

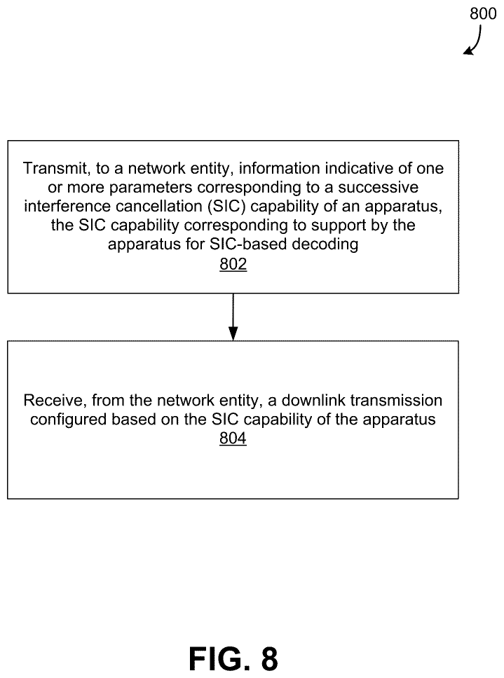

FIG. 8 is a flowchart diagram illustrating an example of a process 800 for wireless communications. In some aspects, the process 800 can be a process for wireless communications by a network entity (e.g., a UE, etc.). For example, the process 800 can be a process for wireless communications by a UE. In some examples, the process 800 can be performed by a network entity or network device (or apparatus) or a component (e.g., a chipset, codec, etc.) of the network entity or device. The process 800 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 800 may be implemented as software components that are executed and run on one or more processors (e.g., processor 910 and/or processing system 902 of FIG. 9, or other processor(s)).

In some examples, the process 800 can be performed by a UE, including any of the various UEs described herein. In some aspects, the process 800 can be performed by a UE, smartphone, mobile computing device, user computer device, etc. The process 800 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; computing system 900 and/or processing system 902 of FIG. 9; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.). Further, the transmission and reception of signals by the network entity in the process 800 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254 a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

At block 802, the apparatus (or component thereof) can transmit, to a network entity, information indicative of one or more parameters corresponding to a successive interference cancellation (SIC) capability of the apparatus, the SIC capability corresponding to support by the apparatus for SIC-based decoding. For example, the apparatus can be a UE configured to transmit, to a network entity (e.g., base station, gNB, etc.) information indicative of the SIC capability and/or SIC decoding capability of the UE. In some examples, the one or more parameters are parameters associated with a downlink transmission transmitted by the network entity and received by the apparatus or component thereof (e.g., UE or component thereof, etc.). The information can include one or more threshold values corresponding to the one or more parameters.

In some cases, the information is SIC capability information indicative of a capability of the apparatus to support or not support SIC-based decoding of a spatially coupled (SC) multiple-input multiple-output (SC-MIMO) transmission. For example, the information can be SIC capability information indicative of a capability of the apparatus (e.g., UE) to support or not support SIC-based decoding of SC-MIMO transmissions from the network entity. In some examples, the one or more parameters includes at least one of: a threshold number of code blocks (CBs) for the apparatus (e.g., UE) to perform SIC-based decoding of a downlink transmission transmitted from the network entity to the apparatus (e.g., UE), a threshold modulation coding scheme (MCS) index value for the apparatus (e.g., UE) to perform SIC-based decoding of the downlink transmission form the network entity, or a threshold number of allocated time-frequency resources for the apparatus (e.g., UE) to perform SIC-based decoding of the downlink transmission from the network entity.

In some cases, the one or more parameters includes a threshold decoding time for the apparatus (e.g., UE) to perform SIC-based decoding of a downlink transmission from the network entity. In some examples, the one or more parameters includes a threshold of remaining energy for the apparatus (e.g., UE) to perform SIC-based decoding of a downlink transmission from the network entity. In some cases, the one or more parameters includes a threshold number of spatial layers of a spatially coupled (SC) multiple-input multiple-output (SC-MIMO) communication link associated with a downlink transmission from the network entity to the apparatus (e.g., UE), for the apparatus (e.g., UE) to perform SIC-based decoding of the downlink transmission.

In some examples, the information indicative of the one or more parameters corresponding to the SIC capability of the apparatus (e.g., UE) is included in uplink control information (UCI) transmitted from the apparatus (e.g., UE) to the network entity. For example, the apparatus (e.g., UE) can transmit UCI to the network entity, where the UCI includes and/or indicates the SIC capability information of the apparatus (e.g., UE). In some cases, the information indicative of the one or more parameters corresponding to the SIC capability of the apparatus (e.g., UE) is included in a channel quality indicator (CQI) or a physical uplink shared channel (PUSCH) payload transmitted from the apparatus (e.g., UE) to the network entity. For example, the apparatus (e.g., UE) can transmit a CQI or PUSCH payload to the network entity, where the CQI or PUSCH payload includes and/or indicates the SIC capability information of the apparatus (e.g., UE).

At block 804, the apparatus (or component thereof) can receive, from the network entity, a downlink transmission configured based on the SIC capability of the apparatus. For example, in some cases the downlink transmission comprises an SC-MIMO transmission, and the SIC capability information is indicative of a capability of the apparatus to support SIC-based decoding of the downlink transmission based on the downlink transmission being configured with respective values for the one or more parameters where the respective values are within the one or more threshold values.

In some cases, the one or more parameters includes a threshold number of code blocks (CBs) for the SIC capability of the apparatus, and the SIC capability comprises support for SIC-based decoding based on the downlink transmission including a first number of CBs within the threshold number of CBs.

In some cases, the apparatus (or component thereof) (e.g., UE) can be configured to perform SIC-based decoding of the downlink transmission based on a number of CBs associated with the downlink transmission being within the threshold number of CBs for the SIC capability. In some examples, the information comprises SIC capability information indicative of support by the apparatus (e.g., UE) to perform SIC-based decoding of a spatially coupled (SC) multiple-input multiple-output (SC-MIMO) transmission. In some cases, the SIC capability information enables the network entity to enable SIC for the downlink transmission based on the SIC capability information. In some examples, the information comprises SIC capability information indicating the apparatus (e.g., UE) does not support SIC-based decoding of a spatially coupled (SC) multiple-input multiple-output (SC-MIMO) transmission. In some cases, the SIC capability information enables the network entity to disable SIC for the downlink transmission based on the SIC capability information.

In some examples, the processes described herein (e.g., process 800 and/or other process described herein) may be performed by a computing device or apparatus (e.g., a network node such as a UE, base station, a portion of a base station, etc.). For example, as noted above, the process 800 may be performed by a UE and/or network entity (e.g., base station, gNB, etc.). In some examples, the process 800 may be performed by a computing device with the computing system 900 shown in FIG. 9. For example, a wireless communication device with the computing architecture shown in FIG. 9 may include the components of the UE and/or the network entity (e.g., base station, gNB, etc.) and may implement the operations of FIG. 8 and/or process 800, etc.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the BluetoothTM standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 800 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900 including a processing system 902, which may be for example any computing device making up internal computing system, a remote computing system, a camera, or any component thereof in which the components of the system are in communication with each other using connection 905. Connection 905 may be a physical connection using a bus, or a direct connection into processor 910 (and/or one or more other processors included within and/or associated with the processing system 902), such as in a chipset architecture. Connection 905 may also be a virtual connection, networked connection, or logical connection.

In some aspects, computing system 900 and/or the processing system 902 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 902 includes at least one processing unit (CPU or processor) 910 and connection 905 that communicatively couples various system components including system memory 915, such as read-only memory (ROM) 920 and random access memory (RAM) 925 to processor 910. The processing system 902 may include a cache 912 of high-speed memory connected directly with, in close proximity to, or integrated as part of processor 910 and/or one or more other processors included within and/or associated with the processing system 902.

Processor 910 may include any general-purpose processor and a hardware service or software service, such as services 932, 934, and 936 stored in storage device 930, configured to control processor 910 and/or one or more other processors included within and/or associated with the processing system 902, as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, processing system 902 includes an input device 945, which may represent any number of input mechanisms, such as a microphone for speech, a touch-sensitive screen for gesture or graphical input, keyboard, mouse, motion input, speech, etc. Processing system 902 may also include output device 935, which may be one or more of a number of output mechanisms. In some examples, multimodal systems may enable a user to provide multiple types of input/output to communicate with processing system 902.

Processing system 902 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a BluetoothTM wireless signal transfer, a BluetoothTM low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard, and Visa (EMV) chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910 and/or one or more other processors included within and/or associated with the processing system 902, it causes the system to perform a function. In some aspects, a hardware service that performs a particular function may include the software component stored in a computer-readable medium in connection with the necessary hardware components, such as processor 910 (e.g., and/or one or more other processors included within and/or associated with the processing system 902), connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for wireless communication, comprising: a processing system configured to: transmit, to a network entity, information indicative of one or more parameters corresponding to a successive interference cancellation (SIC) capability of the apparatus, the SIC capability corresponding to support by the apparatus for SIC-based decoding; and receive, from the network entity, a downlink transmission configured based on the SIC capability of the apparatus.
Aspect 2. The apparatus of Aspect 1, wherein the one or more parameters are parameters associated with the downlink transmission, and wherein the information includes one or more threshold values corresponding to the one or more parameters.
Aspect 3. The apparatus of Aspect 2, wherein the information is SIC capability information indicative of a capability of the apparatus to support or not support SIC-based decoding of a spatially coupled (SC) multiple-input multiple-output (SC-MIMO) transmission.
Aspect 4. The apparatus of Aspect 3, wherein: the downlink transmission comprises an SC-MIMO transmission; and the SIC capability information is indicative of a capability of the apparatus to support SIC-based decoding of the downlink transmission based on the downlink transmission being configured with respective values for the one or more parameters where the respective values are within the one or more threshold values.
Aspect 5. The apparatus of any of Aspects 1 to 4, wherein: the one or more parameters includes a threshold number of code blocks (CBs) for the SIC capability of the apparatus; and the SIC capability comprises support for SIC-based decoding based on the downlink transmission including a first number of CBs within the threshold number of CBs.
Aspect 6. The apparatus of Aspect 5, wherein the processing system is configured to: perform SIC-based decoding of the downlink transmission based on a number of CBs associated with the downlink transmission being within the threshold number of CBs for the SIC capability.
Aspect 7. The apparatus of any of Aspects 1 to 6, wherein the one or more parameters includes at least one of: a threshold number of code blocks (CBs) for the apparatus to perform SIC-based decoding of the downlink transmission, a threshold modulation coding scheme (MCS) index value for the apparatus to perform SIC-based decoding of the downlink transmission, or a threshold number of allocated time-frequency resources for the apparatus to perform SIC-based decoding of the downlink transmission.
Aspect 8. The apparatus of any of Aspects 1 to 7, wherein the one or more parameters includes a threshold decoding time for the apparatus to perform SIC-based decoding of the downlink transmission.
Aspect 9. The apparatus of any of Aspects 1 to 8, wherein the one or more parameters includes a threshold of remaining energy for the apparatus to perform SIC-based decoding of the downlink transmission.
Aspect 10. The apparatus of any of Aspects 1 to 9, wherein the one or more parameters includes a threshold number of spatial layers of a spatially coupled (SC) multiple-input multiple-output (SC-MIMO) communication link associated with the downlink transmission for the apparatus to perform SIC-based decoding of the downlink transmission.
Aspect 11. The apparatus of any of Aspects 1 to 10, wherein the information indicative of the one or more parameters corresponding to the SIC capability of the apparatus is included in uplink control information (UCI) transmitted from the apparatus to the network entity.
Aspect 12. The apparatus of any of Aspects 1 to 11, wherein the information indicative of the one or more parameters corresponding to the SIC capability of the apparatus is included in a channel quality indicator (CQI) or a physical uplink shared channel (PUSCH) payload transmitted from the apparatus to the network entity.
Aspect 13. The apparatus of any of Aspects 1 to 12, wherein: the information comprises SIC capability information indicative of support by the apparatus to perform SIC-based decoding of a spatially coupled (SC) multiple-input multiple-output (SC-MIMO) transmission; and the SIC capability information enables the network entity to enable SIC for the downlink transmission based on the SIC capability information.
Aspect 14. The apparatus of any of Aspects 1 to 13, wherein: the information comprises SIC capability information indicating the apparatus does not support SIC-based decoding of a spatially coupled (SC) multiple-input multiple-output (SC-MIMO) transmission; and the SIC capability information enables the network entity to disable SIC for the downlink transmission based on the SIC capability information.
Aspect 15. A method for wireless communication by a user equipment (UE), comprising: transmitting, to a network entity, information indicative of one or more parameters corresponding to a successive interference cancellation (SIC) capability of the UE, the SIC capability corresponding to support by the UE for SIC-based decoding; and receiving, from the network entity, a downlink transmission configured based on the SIC capability of the UE.
Aspect 16. The method of Aspect 15, wherein the one or more parameters are parameters associated with the downlink transmission, and wherein the information includes one or more threshold values corresponding to the one or more parameters.
Aspect 17. The method of Aspect 16, wherein the information is SIC capability information indicative of a capability of the UE to support or not support SIC-based decoding of a spatially coupled (SC) multiple-input multiple-output (SC-MIMO) transmission.
Aspect 18. The method of Aspect 17, wherein: the downlink transmission comprises an SC-MIMO transmission; and the SIC capability information is indicative of a capability of the UE to support SIC-based decoding of the downlink transmission based on the downlink transmission being configured with respective values for the one or more parameters where the respective values are within the one or more threshold values.
Aspect 19. The method of any of Aspects 15 to 18, wherein: the one or more parameters includes a threshold number of code blocks (CBs) for the SIC capability of the UE; and the SIC capability comprises support for SIC-based decoding based on the downlink transmission including a first number of CBs within the threshold number of CBs.
Aspect 20. The method of Aspect 19, further comprising: performing SIC-based decoding of the downlink transmission based on a number of CBs associated with the downlink transmission being within the threshold number of CBs for the SIC capability.
Aspect 21. The method of any of Aspects 15 to 20, wherein the one or more parameters includes at least one of: a threshold number of code blocks (CBs) for the UE to perform SIC-based decoding of the downlink transmission, a threshold modulation coding scheme (MCS) index value for the UE to perform SIC-based decoding of the downlink transmission, or a threshold number of allocated time-frequency resources for the UE to perform SIC-based decoding of the downlink transmission.
Aspect 22. The method of any of Aspects 15 to 21, wherein the one or more parameters includes a threshold decoding time for the UE to perform SIC-based decoding of the downlink transmission.
Aspect 23. The method of any of Aspects 15 to 22, wherein the one or more parameters includes a threshold of remaining energy for the UE to perform SIC-based decoding of the downlink transmission.
Aspect 24. The method of any of Aspects 15 to 23, wherein the one or more parameters includes a threshold number of spatial layers of a spatially coupled (SC) multiple-input multiple-output (SC-MIMO) communication link associated with the downlink transmission for the UE to perform SIC-based decoding of the downlink transmission.
Aspect 25. The method of any of Aspects 15 to 24, wherein the information indicative of the one or more parameters corresponding to the SIC capability of the UE is included in uplink control information (UCI) transmitted from the UE to the network entity.
Aspect 26. The method of any of Aspects 15 to 25, wherein the information indicative of the one or more parameters corresponding to the SIC capability of the UE is included in a channel quality indicator (CQI) or a physical uplink shared channel (PUSCH) payload transmitted from the UE to the network entity.
Aspect 27. The method of any of Aspects 15 to 26, wherein: the information comprises SIC capability information indicative of support by the UE to perform SIC-based decoding of a spatially coupled (SC) multiple-input multiple-output (SC-MIMO) transmission; and the SIC capability information enables the network entity to enable SIC for the downlink transmission based on the SIC capability information.
Aspect 28. The method of any of Aspects 15 to 27, wherein: the information comprises SIC capability information indicating the UE does not support SIC-based decoding of a spatially coupled (SC) multiple-input multiple-output (SC-MIMO) transmission; and the SIC capability information enables the network entity to disable SIC for the downlink transmission based on the SIC capability information.
Aspect 29. A non-transitory computer-readable storage medium comprising instructions stored thereon which, when executed by at least one processor, causes the at least one processor to perform operations according to any of Aspects 1 to 14.
Aspect 30. An apparatus for wireless communication comprising one or more means for performing operations according to any of Aspects 1 to 14.

What is claimed is:

1. An apparatus for wireless communication, comprising:
a processing system configured to:
transmit, to a network entity, information indicative of one or more parameters corresponding to a successive interference cancellation (SIC) capability of the apparatus, the SIC capability corresponding to support by the apparatus for SIC-based decoding; and
receive, from the network entity, a downlink transmission configured based on the SIC capability of the apparatus.

2. The apparatus of claim 1, wherein the one or more parameters are parameters associated with the downlink transmission, and wherein the information includes one or more threshold values corresponding to the one or more parameters.

3. The apparatus of claim 2, wherein the information is SIC capability information indicative of a capability of the apparatus to support or not support SIC-based decoding of a spatially coupled (SC) multiple-input multiple-output (SC-MIMO) transmission.

4. The apparatus of claim 3, wherein:
the downlink transmission comprises an SC-MIMO transmission; and
the SIC capability information is indicative of a capability of the apparatus to support SIC-based decoding of the downlink transmission based on the downlink transmission being configured with respective values for the one or more parameters where the respective values are within the one or more threshold values.

5. The apparatus of claim 1, wherein:
the one or more parameters includes a threshold number of code blocks (CBs) for the SIC capability of the apparatus; and
the SIC capability comprises support for SIC-based decoding based on the downlink transmission including a first number of CBs within the threshold number of CBs.

6. The apparatus of claim 5, wherein the processing system is configured to:
perform SIC-based decoding of the downlink transmission based on a number of CBs associated with the downlink transmission being within the threshold number of CBs for the SIC capability.

7. The apparatus of claim 1, wherein the one or more parameters includes at least one of: a threshold number of code blocks (CBs) for the apparatus to perform SIC-based decoding of the downlink transmission, a threshold modulation coding scheme (MCS) index value for the apparatus to perform SIC-based decoding of the downlink transmission, or a threshold number of allocated time-frequency resources for the apparatus to perform SIC-based decoding of the downlink transmission.

8. The apparatus of claim 1, wherein the one or more parameters includes a threshold decoding time for the apparatus to perform SIC-based decoding of the downlink transmission.

9. The apparatus of claim 1, wherein the one or more parameters includes a threshold of remaining energy for the apparatus to perform SIC-based decoding of the downlink transmission.

10. The apparatus of claim 1, wherein the one or more parameters includes a threshold number of spatial layers of a spatially coupled (SC) multiple-input multiple-output (SC-MIMO) communication link associated with the downlink transmission for the apparatus to perform SIC-based decoding of the downlink transmission.

11. The apparatus of claim 1, wherein the information indicative of the one or more parameters corresponding to the SIC capability of the apparatus is included in uplink control information (UCI) transmitted from the apparatus to the network entity.

12. The apparatus of claim 1, wherein the information indicative of the one or more parameters corresponding to the SIC capability of the apparatus is included in a channel quality indicator (CQI) or a physical uplink shared channel (PUSCH) payload transmitted from the apparatus to the network entity.

13. The apparatus of claim 1, wherein:
the information comprises SIC capability information indicative of support by the apparatus to perform SIC-based decoding of a spatially coupled (SC) multiple-input multiple-output (SC-MIMO) transmission; and
the SIC capability information enables the network entity to enable SIC for the downlink transmission based on the SIC capability information.

14. The apparatus of claim 1, wherein:
the information comprises SIC capability information indicating the apparatus does not support SIC-based decoding of a spatially coupled (SC) multiple-input multiple-output (SC-MIMO) transmission; and
the SIC capability information enables the network entity to disable SIC for the downlink transmission based on the SIC capability information.

15. A method for wireless communication by a user equipment (UE), comprising:
transmitting, to a network entity, information indicative of one or more parameters corresponding to a successive interference cancellation (SIC) capability of the UE, the SIC capability corresponding to support by the UE for SIC-based decoding; and
receiving, from the network entity, a downlink transmission configured based on the SIC capability of the UE.

16. The method of claim 15, wherein the one or more parameters are parameters associated with the downlink transmission, and wherein the information includes one or more threshold values corresponding to the one or more parameters.

17. The method of claim 16, wherein the information is SIC capability information indicative of a capability of the UE to support or not support SIC-based decoding of a spatially coupled (SC) multiple-input multiple-output (SC-MIMO) transmission.

18. The method of claim 17, wherein:
the downlink transmission comprises an SC-MIMO transmission; and
the SIC capability information is indicative of a capability of the UE to support SIC-based decoding of the downlink transmission based on the downlink transmission being configured with respective values for the one or more parameters where the respective values are within the one or more threshold values.

19. The method of claim 15, wherein:
the one or more parameters includes a threshold number of code blocks (CBs) for the SIC capability of the UE; and
the SIC capability comprises support for SIC-based decoding based on the downlink transmission including a first number of CBs within the threshold number of CBs.

20. A non-transitory computer-readable storage medium comprising instructions stored thereon which, when executed by a processing system of an apparatus, causes the processing system to:
transmit, to a network entity, information indicative of one or more parameters corresponding to a successive interference cancellation (SIC) capability of the apparatus, the SIC capability corresponding to support by the apparatus for SIC-based decoding; and
receive, from the network entity, a downlink transmission configured based on the SIC capability of the apparatus.
